(19) United States
(12) Patent Application Publication
(10) Pub. No.: US 2017/0161450 A1
(43) Pub. Date: Jun. 8, 2017

(54) REAL-TIME VETERINARIAN COMMUNICATION LINKAGE FOR ANIMAL ASSESSMENT AND DIAGNOSIS

(71) Applicant: DOG VISION VENTURES, LLC, Austin, TX (US)

(72) Inventors: Christian Robert White, Austin, TX (US); Joshua Jeremiah Fuglsby, Winnetka, CA (US)

(21) Appl. No.: 14/957,917

(22) Filed: Dec. 3, 2015

(51) Int. Cl. G06F 19/00; H04N 7/14

(52) U.S. Cl. CPC G06F 19/3418; G06F 19/322; H04N 7/147

(57) ABSTRACT

Systems, methods, and apparatuses are provided for real-time veterinarian communication linkage for animal assessment and diagnosis. The system enables an animal subject associated with a user to receive preventative, diagnostic or treatment related healthcare, via a real-time veterinary medicine session between the user and the at least one veterinarian associated with the veterinary medicine system. In this regard, the animal subject and the at least one veterinarian may be situated at different locations. The system establishes a video communication link between a veterinarian system associated with the at least one veterinarian and the user device to enable transfer of textual, audio and video communication, related to the symptoms, illnesses and the diagnosis of the animal subject, via the communication link.

### BACKGROUND

Animals are an important part of our society. Animals are domesticated for a wide variety of reasons. Animals may be companion animals or pets for a user's protection and/or company. Animal may also include livestock, working animals, and the like. Typically, animals require persistent care and medical attention from veterinarians to ensure their health and wellbeing. However, veterinarians may not be available in all geographic areas and may not be available as quickly as needed. Furthermore, transporting animals to visit veterinarians may pose difficulties, may be time consuming and deleterious to the animals' heath in some instances.

Animals may be large in size, difficult to restrain and therefore be difficult to transport to a clinic or a veterinarian facility for diagnostic, preventative and treatment related care. The animal may be too young, recuperating from a recent surgery, too assertive, fearful of the clinical environment or may possess an infectious illness and therefore be unsuitable for an in-person visit. The animals may be familiar with or indigenous to certain remote environments and ecosystems, away from the veterinarian facilities, that may not be easily reproducible during transport and during the session with the veterinarian. In addition, users with physical disabilities may find it difficult to travel and transport the animal subjects to a distant veterinarian.

Therefore a need exists for a system that enables animals to receive preventative, diagnostic and treatment related care, even in instances where in-person visits are not feasible.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Embodiments of the invention are directed to systems, methods, apparatuses and computer program products for real-time veterinarian communication linkage for animal subject assessment and diagnosis. The system, in some embodiments, includes a non-transitory computer-readable storage medium including computer-readable program code and a processor coupled to the computer readable storage medium configured to execute the computer readable program code. The system is configured to establish an operative communication link with a user device associated with a user, the user being associated with an animal subject; receive, via the operative communication link, a request from the user to initiate a veterinary medicine session; determine one or more veterinarians associated with a veterinary medicine system and transmit information associated with the one or more veterinarians to the user device; receive, via the operative communication link, a selection of at least one veterinarian of the one or more veterinarians from the user; establish a video communication link between a veterinarian system associated with the at least one veterinarian and the user device; initiate a real-time veterinary medicine session between the user and the at least one veterinarian associated with the veterinary medicine system, wherein initiating the veterinary medicine session further comprises: capturing a first content from the user device and transmitting the first content to the at least one veterinarian, wherein the first content comprises symptoms of the animal subject; enabling the at least one veterinarian to perform preventative, diagnostic or treatment related functions; and capturing a second content from the veterinarian system and transmitting the second content to the user, wherein the second content comprises a diagnosis and a prescribed medication associated with the animal subject; and close the video communication link and configure the first content and the second content for future storage and retrieval.

In some embodiments, and in combination with the above embodiment, determining the one or more veterinarians associated with a veterinary medicine system, further comprises: retrieving at least a portion of a medical history associated with the animal subject; determining a user location; determining the one or more veterinarians of a plurality of veterinarians associated with the veterinary medicine system based on at least the retrieved medical history and the user location; and transmitting the retrieved medical history to the veterinarian system associated with the at least one veterinarian of the one or more veterinarians, selected by the user.

In some embodiments, and in combination with any of the above embodiments, the first content and the second content comprise at least one of textual content, audio content and video content.

In some embodiments, and in combination with any of the above embodiments, the system is further configured to: receive, via the operative communication link, one or more images from the user device via an image capture device; enhance each of the one or more images, wherein enhancing each of the one or more images further comprises at least one of enhancing a resolution of the image, enhancing sharpness of the image, modifying layers of the image and eliminating distortions; encode a time-stamp on each of the one or more enhanced images; and transmit the one or more images comprising the time-stamp to the veterinarian system associated with the at least one veterinarian.

In some embodiments, and in combination with any of the above embodiments, the system is further configured to: retrieve, via the operative communication link, application information from the user device; determine a first portion one or more auxiliary devices that are currently connected to the user device or that have been previously connected to the user device, based on analyzing the application information, wherein the one or more auxiliary devices are configured to determine one or more diagnostic parameters associated with the animal subject; receive, via the operative communication link, a second portion of the one or more auxiliary devices from the user; transmit control instructions to the one or more auxiliary devices that cause the one or more auxiliary devices to transmit the one or more diagnostic parameters associated with the animal subject; and transform the one or more diagnostic parameters into a second format and display the one or more parameters on the veterinarian system and the user device.

In some embodiments, and in combination with any of the above embodiments, configuring the first content and the second content for future storage and retrieval further comprises, augmenting a medical history of the animal subject with the first content and the second content.

In some embodiments, and in combination with any of the above embodiments, the system is further configured to: receive, from the veterinarian system, second content comprising the prescribed medication associated with the animal subject; determine one or more pharmacies based on at least the prescribed medication and a determined user location; receive, via the operative communication link, a selection of at least one pharmacy of the one or more pharmacies from the user; and transmit an order associated with the prescribed medication to the at least one pharmacy

In some embodiments, and in combination with any of the above embodiments, transmitting information associated with the one or more veterinarians to the user device further comprises: determining an ordering criteria for a display of the determined one or more veterinarians on the user device, wherein the ordering criteria comprises previous sessions with the animal subject, lowest wait time, shortest distance from a user location and relevant veterinary specialization; and initiating the display of the one or more veterinarians on the user device based on the determined order, wherein initiating the display of the one or more veterinarians further comprises displaying one or more veterinarian details chosen from a group comprising: an image associated with the veterinarian, contact information, certifications, specialization, number of years of experience, accepted insurance providers and average wait times.

In some embodiments, the system is configured to: establish an operative communication link with a user device associated with a user, the user being associated with an animal subject; receive, via the operative communication link, a request from the user to initiate a veterinary medicine session; determine at least one veterinarian associated with a veterinary medicine system; establish a video communication link between a veterinarian system associated with the at least one veterinarian and the user device; retrieve, via the operative communication link, application information from the user device; determine one or more auxiliary devices that are configured to determine one or more diagnostic parameters associated with the animal subject; initiate a real-time veterinary medicine session between the user and the at least one veterinarian associated with the veterinary medicine system, wherein initiating the veterinary medicine session further comprises: capturing a first content from the user device and transmitting the first content to the at least one veterinarian, wherein the first content comprises symptoms of the animal subject; receiving, one or more images from the user device via an image capture device; enhancing each of the one or more images, wherein enhancing each of the one or more images further comprises at least one of enhancing a resolution of the image, enhancing sharpness of the image, modifying layers of the image and eliminating distortions; encoding a time-stamp on each of the one or more enhanced images and transmitting the one or more images to the veterinarian system; transmitting control instructions to the one or more auxiliary devices, that cause the one or more auxiliary devices to transmit the one or more diagnostic parameters associated with the animal subject and transmitting the received diagnostic parameters to the veterinarian system; enabling the at least one veterinarian to perform preventative, diagnostic or treatment related functions; and capturing a second content from the veterinarian system and transmitting the second content to the user, wherein the second content comprises a diagnosis and a prescribed medication associated with the animal subject; and close the video communication link and configure the first content and the second content for future storage and retrieval.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a flowchart illustrating real-time veterinarian communication linkage for animal assessment and diagnosis, according to an embodiment of the present invention;

FIG. 2 provides a flowchart illustrating connecting the user device to a veterinary medicine system, in accordance with various embodiments of the invention;

FIG. 3 provides a flowchart illustrating establishing a video communication link between the user device and the at least one veterinarian associated with the veterinary medicine system, in accordance with various embodiments of the invention;

FIG. 4 provides a flowchart illustrating connecting one or more auxiliary devices to the veterinary medicine system, in accordance with various embodiments of the invention;

FIG. 5 provides a flowchart illustrating enabling preventative, diagnostic or treatment related functions, in accordance with an embodiment of the present invention; and

FIG. 6 provides a block diagram a block diagram of a veterinary medicine system environment, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The invention is directed to, in general, providing preventative, diagnostic or treatment related care to one or more animal subjects. Specifically, the invention relates to applying veterinary medicine for prevention, diagnosis and treatment of disease, disorder and injury and general well-being of animal subjects. In this regard, embodiments of the invention are directed to establishing real-time veterinarian communication sessions between the animal subjects and one or more veterinarians, for animal subject assessment and diagnosis. Typically, the sessions are facilitated between the animal subjects and the veterinarians via one or more users and one or more user devices. As such, the invention is directed to a proactive, real-time and interactive system for delivering animal healthcare solutions to ensure the health and well-being of the animal subjects.

Typically, the term “user” refers to the owner, caregiver, trained professional, trained/untrained guardian or another individual responsible for, or associated with, the animal subject. The animal subject may refer to one or more animals, comprising mammals, amphibians, reptiles, birds, fishes, arthropods and other vertebrates and invertebrates. In some embodiments, the animal subject may refer to a domesticated animals comprising pets or companion animals, livestock, working animals, and the like. Although, dogs and cats may be more common pets, pet animals may also comprise rabbits, ferrets, rodents like gerbils and hamsters, avian pets such as parrots, pigeons and canaries, aquatic pets like fish, turtles and frogs, reptile and arthropod pets. Livestock animals and working animals may comprise cattle, goats, horses, deer, camels, sheep, poultry, and the like. In some embodiments, animal subject may refer to wild and non-domesticated animals. The animal subjects named above do not constitute an exhaustive list, but are provided for the purpose of illustration. Animal subjects, as referred to in this disclosure may typically comprise one or more non-human animals alluded to above and/or one or more animals not mentioned above.

The term “veterinarian” may refer to a veterinary physician, a veterinary surgeon, paraveterinary workers, nurses and technicians and other professionals trained and certified in veterinary medicine. In some embodiments, veterinarians may be general practice veterinarians, while in other embodiments, the veterinarians may specialize in practice areas comprising, but not limited to, small animal practice, large animal practice, equine medicine, food animal medicine, food safety medicine, aquatic medicine, wildlife medicine, animal behavior, veterinary dentistry, veterinary dermatology, internal medicine, veterinary neurology, veterinary radiology, preventative medicine, animal nutrition, veterinary surgery, and the like.

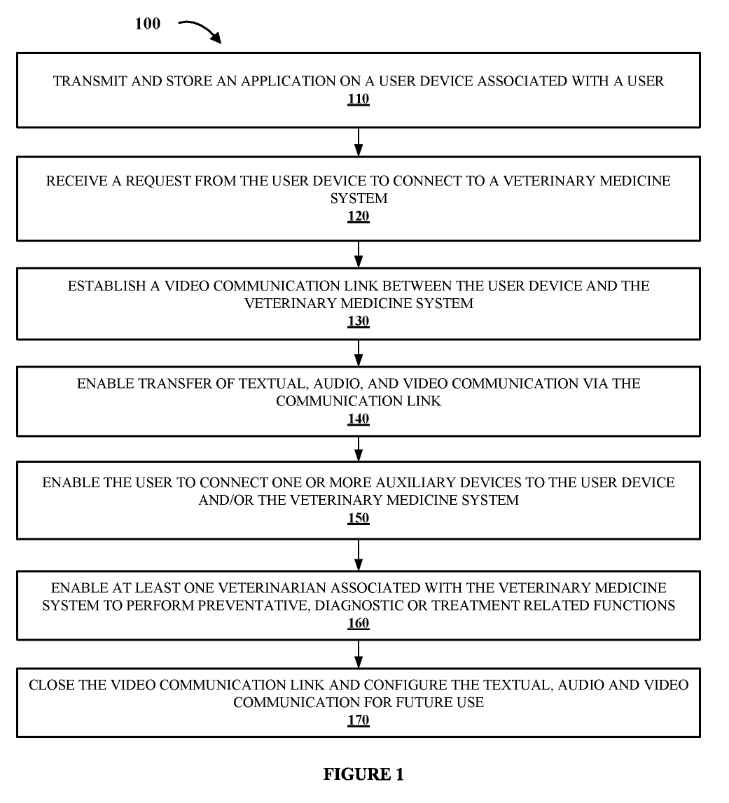

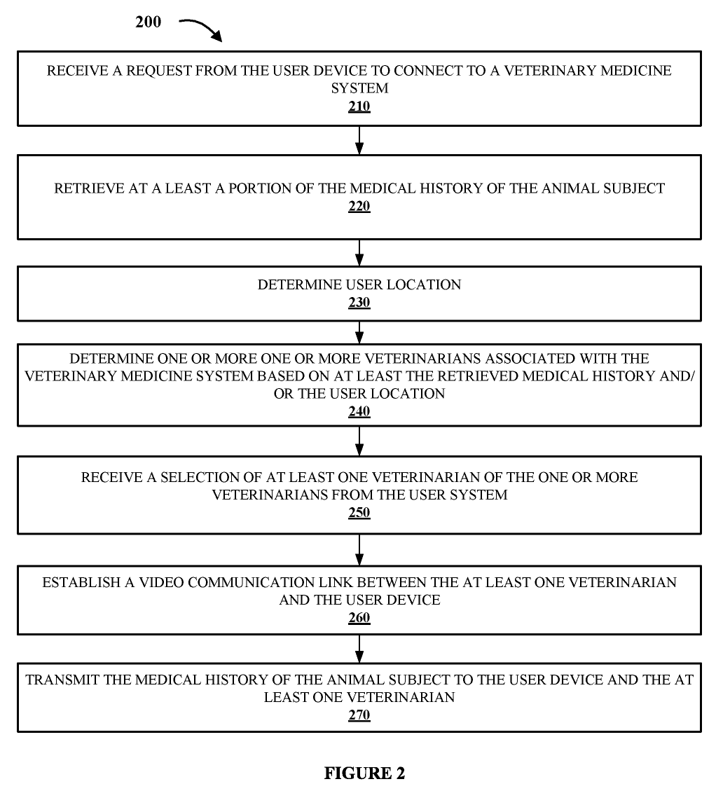

FIG. 1 illustrates a high level process flow 100 for real-time veterinarian communication linkage for animal assessment and diagnosis, according to embodiments of the invention. As discussed in detail elsewhere in the disclosure, one or more steps the process flow 100 may be performed by a system or apparatus comprising one or more of a veterinary medicine system, user device systems, veterinarian systems and other systems and devices. It should be understood that the process flow 100 and subsequent process flows 200-500, illustrated in FIGS. 2-5, may be performed either entirely, or in part by the veterinary medicine system, user device systems, veterinarian systems and/or other devices and systems, either individually or in combination. In some embodiments the system may refer to the veterinary medicine system that is configured to operatively communicate with user device systems, veterinarian systems, auxiliary devices and other systems. In other embodiments the system may collectively refer to the veterinary medicine system and the veterinarian system that are configured to perform one or more steps of the process flows described herein, either singular or in combination with other systems. In some embodiments, the user associated with the animal subject is enabled to engage or participate in a real-time veterinarian communication session with one or more veterinarians via the user device system and the veterinary medicine system. In this regard, the one or more veterinarians may perform preventative, diagnostic or treatment related functions using veterinarian systems, via the veterinary medicine system. In some embodiments, the veterinary medicine system enables operative communication between the user device systems and the veterinarian systems.

The invention is directed to providing preventative, diagnostic or treatment related care to one or more animal subjects. In this regard, in some embodiments, an application may be configured to facilitate one or more steps associated with the high level process flow 100. The application may be stored on the user device system, the veterinary medicine system, the veterinarian system, a cloud network and/or other third party systems and may be configured to provide user interfaces for the one or more systems. In some embodiments, the application is a specific application, configured to perform one or more steps of the process flow 100. Furthermore, in some embodiments the application may be configured to perform one or more unrelated functions, in addition to facilitating real-time veterinarian communication linkage for animal assessment and diagnosis. The application may provide one or more audiovisual interfaces at a suitable system. When at least a portion of the application is stored on the veterinary medicine system, the application may be referred to as a veterinary medicine application. In instances where at least a portion of the application is stored on the user device system, the application may be referred to as a user application. In some embodiments, the user application is an application or widget stored on the user device. In some embodiments, the user application is a browser application configured to enable the user to access the veterinary medicine system. The veterinary medicine application may be similar in structure and function as the user application, while in other embodiments the applications may be dissimilar. In some embodiments, the veterinary medicine application is configured to transmit control instructions to the user application that cause the user application to perform one or more specific functions. In some embodiments, the veterinary medicine application may comprise instructions that when executed cause the system to perform one or more steps of the process flows 100-500. In some embodiments, the one or more veterinarians access the veterinary medicine application via the veterinarian systems and/or the veterinary medicine application provides an audio, visual and/or tactile interface at the veterinarian systems to enable the veterinarians to participate in the diagnostic sessions of the animal subjects. In some embodiments, the system provides the user application and/or the veterinary medicine application comprising an intelligent personal assistant and knowledge navigator to enable the user and/or the one or more veterinarians to effectively navigate the interface with ease.

In some embodiments the system transmits and stores the user application on a user device associated with the user, as illustrated by block 110 of FIG. 1. In some embodiments, the user application may be stored entirely on a data storage associated with the user device. In some embodiments, the at least a portion of the user application may reside on the user device, in a connected device, an external system, a third party system, any other external system and may be accessible to the user device via a network. The user device or the user device system may comprise computing devices like laptop computers, desktop computers, personal digital assistants, mobile devices like smart phones, tablets, cellular phones, other electronic devices like smart TVs, gaming consoles, voice command devices and wearable devices like smart watches, glasses, fitness devices, and the like. In some embodiments, the user device may refer to one of the above devices while in other embodiments, the user device may collectively refer to a plurality of user devices. In some embodiments, the primary user device (referring to the user devices listed above) may be coupled to one or more secondary user devices comprising speakers, display screens, cameras, microphones, fingerprint scanners, head phones, alarm and notification devices, lighting devices, keyboards, tactile sensors or preceptors, location and movement determining devices like global positioning systems, accelerometers, and the like, while in other embodiments, the secondary user devices are built into or are integral with the primary user devices. Typically, the secondary user devices facilitate or aid in real-time veterinarian communication sessions with the primary user device for animal assessment and diagnosis. In some embodiments, the user device may be configured to operatively communicate with one or more auxiliary devices. In some embodiments, the auxiliary devices are configured to determine one or more diagnostic parameters associated with the animal subject, as described in detail elsewhere in this disclosure.

In some embodiments, the system establishes an operative communication channel with the user device. In some embodiments, the system may access the user device based on receiving the requisite authorization from the user and determine user application information associated with the user. The user application information may comprise one or more applications and widgets stored on the user device, information regarding the type of device and device identifiers (for example, unique device identifiers), information regarding the entities associated with the application (application owner/provider, type of authentication required, and the like), devices that the applications/widgets are configured to control (cameras, GPS systems, auxiliary devices, sensors and other internal and external devices), usage patterns and frequency of use, location of storage of the applications/widgets, and the like. The one or more applications may be stored, at least in part, on the one or more user devices, one or more external systems, and the like. For example, the system may establish operative communication with a first user device comprising a smart phone and determine preliminary application information. Based on analyzing the application information, the system may determine that the user is associated with one or more applications stored on a second user device comprising a tablet computer and one or more applications stored in an external system comprising a cloud computing platform. The system may then retrieve associated user application information based on establishing operative communication channels with the second user device and the external system, either directly or via the first user device. In this regard, the system may seek authentication credentials from the user that are required to access and/or retrieve application information from the send user device and/or the external system.

The system may then analyze the user application information to determine whether at least a portion of the user application is stored on the user device. In the instances where the system determines that the user application is not installed/stored on any of the user devices, the system may then initiate installation of the user application. In this regard, in some embodiments, the system may determine an appropriate user device of the one or more user devices for storing/installing the user application. In some embodiments, after analyzing the application information, the system may choose an appropriate device based on device characteristics such as mobility of the device, secondary devices and other features associated with the device, type of device, authentication features of the device, frequency of use by the user, compatibility with the user application, and/or the auxiliary devices, and the like. For instance, the system may choose an optimal user device based on determining that the device has a larger display screen, a camera with a higher resolution, appropriate or adequate connectivity to a suitable network and/or access to one or more applications required to control an auxiliary device in comparison with other potential user devices. In some embodiments, the system may display potential user devices, arranged in a random order or in a descending order of suitability, and associated device characteristics and receive a selection of a user device for storing the application from the user. In other embodiments, the system may install the user application on all user devices and/or the user may initiate the installation of the user allocation on/from a particular user device. In the instances where the system determines previously installed user application or other applications configured to facilitate one or more steps associated with the high level process flow 100, either alone or in combination with other applications, devices and/or systems, the system may seek to update the application to the most latest version, either periodically or after initiation of a session with a veterinarian. In other embodiments, the system may determine another user device more suitable for the user application and/or the session with the veterinarian based on the factors discussed above and seek to transmit and store at least a portion of the application on the user device.

Next, the system may initiate a session with one or more veterinarians, for animal assessment and diagnosis. In this regard, the system may enable the user to communicate with one or more veterinarians via the veterinary medicine system. In some embodiments, the system may enable communication between the user device and one or more veterinarian systems via a suitable network, either directly or through the veterinary medicine system. In some embodiments, the system may initiate a session with one or more veterinarians based on a trigger event. In some embodiments, as illustrated by block 120 in FIG. 1, the trigger event may comprise the system receiving a request from the user to connect to a veterinary medicine system. In this regard, the user may transmit a request from the user application installed on the user device, by audio commands, gestures, tactile commands directed to one or more user devices or by any other suitable means. In some embodiments, the system may discover prior appointments for a pre-scheduled session, and the trigger event may comprise the date and time associated with the session. In this instance, the system may initiate a session with one or more user devices specified for the scheduled session, one or more veterinary systems associated with the appropriate veterinarians and one or more auxiliary devices deemed necessary, at a predetermined time prior to the start of the session. In some embodiments, the trigger event may be dynamic and proactive, and may comprise determining a deviation, from the optimal threshold value, of the diagnostic parameters of the animal subject received from the one or more auxiliary devices, as disclosed with respect to process flow 400, elsewhere in this specification. In some embodiments, the trigger event may comprise determining that action may be required in response to analyzing user information. For example, the system may analyze the user's social media updates and audio/visual/textual content uploaded by the user, to determine that the animal subject requires preventative, diagnostic and/or treatment related care. As another example, the system may analyze the user's purchase transactions and determine that the animal subject may require care based on identifying one or more purchases associated with the animal subject's health. In some embodiments, the trigger event may comprise receiving a request from one or more veterinarians to connect to the user device. In some embodiments, the system may seek requisite authentication credentials from the user prior to initiating the session. As such, initiating and facilitating a session between the user and one or more suitable veterinarians via the veterinary medicine system, for providing preventative, diagnostic and treatment related care to the animal subject, is described in detail with respect to process flow 200 of FIG. 2, elsewhere in the disclosure.

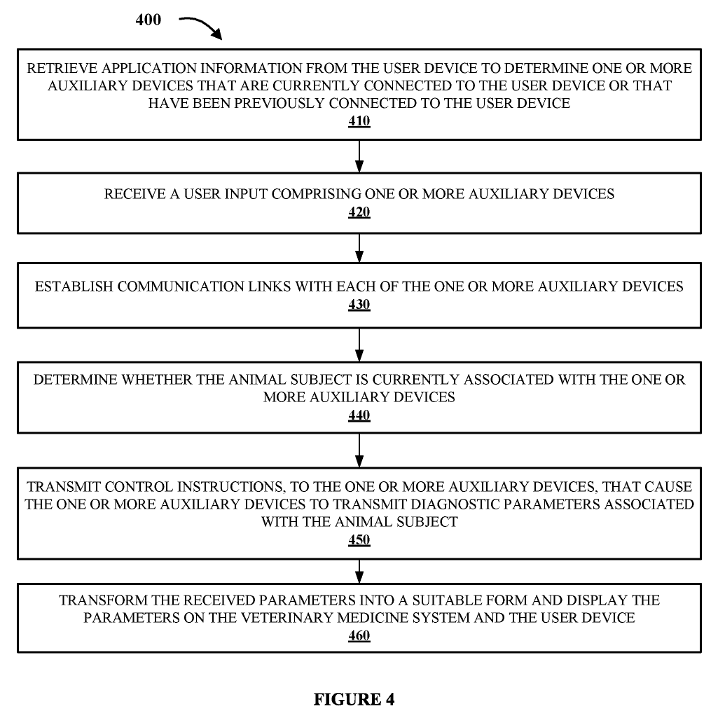

Subsequently, in response to one or more trigger events, the system may establish a video communication link between the user device and the veterinary medicine system, as illustrated by block 130 of FIG. 1. In some embodiments, the video communication link enables real-time audio-visual communication between the user device and one or more veterinarian systems, via the veterinary medicine system. In this regard, in some embodiments the veterinary medicine system enables the reception and transmission of audio and/or video signals, in real-time or near real-time, from the user device and the one or more veterinarian systems at different locations, for communication between the user and the veterinarians in real-time. In some embodiments, establishing the communication link may comprise enabling video chats, voice calls, text and video messages, transfer of files, conference calls, and the like. In some embodiments, the user may provide information associated with the animal subject comprising symptoms, current medication, current diet, behavioral characteristics, and the like, via the video communication link. In some embodiments, the user may additionally provide text, images, videos and/or audio associated with the animal subject captured in real-time and/or images, videos and/or audio captured at a prior instance of time, which are then transmitted to the veterinarian systems via the veterinary medicine system in a suitable format. The one or more veterinarians may seek additional information from the user and/or the veterinary medicine system. Therefore, the system enables transfer of textual, audio, and video communication between the user and the one or more veterinarians, via the communication link, as illustrated by block 140. Communication via the established communication link is described in detail with respect to process flow 400, of FIG. 4, elsewhere in this disclosure.

Block 150 of FIG. 1, illustrates that following the establishment of the communication link between the user device and the veterinarian systems, the system enables the user to connect one or more auxiliary devices to the user device and/or the veterinary medicine system, in accordance with some embodiments of the invention. The auxiliary devices are configured to determine one or more diagnostic parameters associated with the animal subject, and are described in detail, later on with respect to process flow 400 of FIG. 4. The, system receives the diagnostic parameters from the auxiliary device, transforms the parameters suitably and transmits the resultant parameters to the veterinarian systems and/or the veterinary medicine system for analysis and consideration.

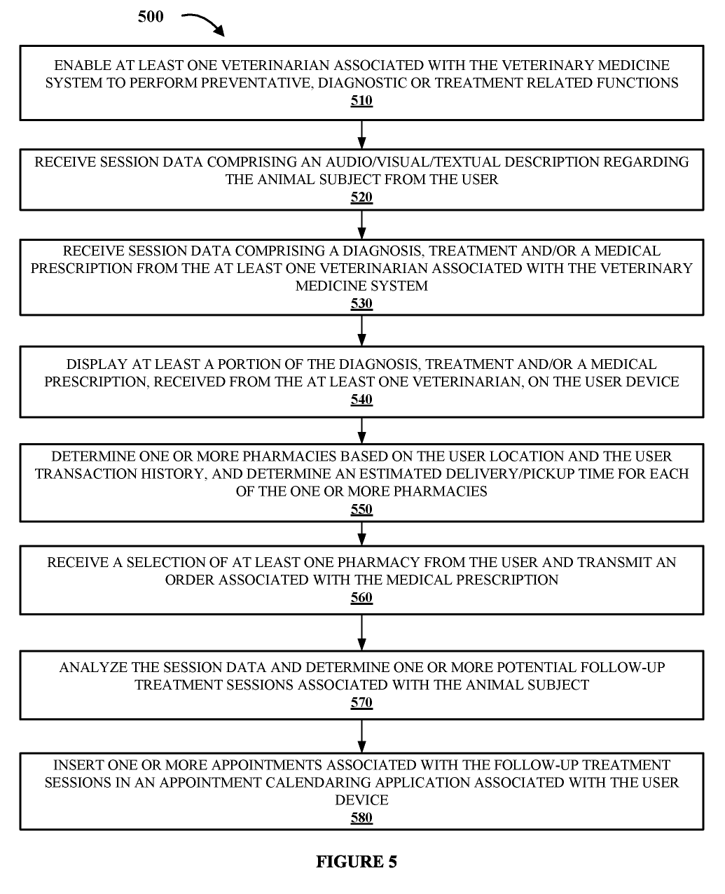

As, illustrated by Block 160 of FIG. 1, the system may then enable at least one veterinarian associated with the veterinary medicine system to perform preventative, diagnostic or treatment related functions, in accordance with some embodiments of the invention. The at least one veterinarian may provide diagnoses, treatment regimes, medical prescriptions, and the like for the animal subject based on analyzing at least the information received from the user and the auxiliary devices, as described in detail with respect to process flow 500 of FIG. 5. Block 170 illustrates that the system may then close the video communication link and configure the textual, audio and video communication for future use. The broad concepts illustrated and described above with respect to the process flow 100 described in FIG. 1, will be described individually or in combination with each other in further detail below.

FIG. 2 illustrates a process flow 200 for initiating and facilitating a session between the user and one or more suitable veterinarians for providing preventative, diagnostic, and treatment related care to the animal subject, in accordance with some embodiments of the invention. As discussed earlier, in some embodiments, the system may initiate a session between the user and the one or more veterinarians based on a trigger event. One such example is a trigger event comprising a request received from the user seeking to connect to a veterinary medicine system and/or one or more veterinarians, as illustrated by block 210 in FIG. 2. In some embodiments, the user may transmit a request from the user application installed on one or more user devices. In some embodiments, the user may transmit a request using an application or widget, distinct from the user application. In some embodiments, the request may comprise audio commands, gestures, tactile commands, and the like received from the user. In some embodiments, the user may initiate the request via one or more graphical control elements, buttons, toggle bars, scroll bars, lists, text boxes, links, and the like provided on the user interface of the user application. In some embodiments, the user may initiate a request via a phone call, email, text message, or any other suitable means. In some embodiments, the user may seek to initiate a session in real-time or in near real-time, while in other embodiments, the user may seek to initiate a session at a time in the future. In some embodiments, the request comprises animal subject information, appointment preferences, user information, and the like. Animal subject information may comprise general information about the animal subject and medical information about the animal subject. For example, the animal subject information may comprise the animal name/identifier, species/subspecies, breed, age, known allergies, current diet, current medication, medical history, prior illnesses and medications, symptoms, physical parameters, and the like. Appointment preferences may comprise appointment time, duration of the appointment, preferred veterinarian, and the like. User information may comprise name, contact information, addresses, user device identifiers, account information, insurance information, and the like. In some embodiments, the system may store the received animal subject information and/or appointment preferences in a suitable memory location (memory locations of the user device, a centralized data repository, database associated with the veterinary medicine system and/or any other suitable memory location) to facilitate ease of access and prompt retrieval for future appointments/sessions. In this regard, the system may create profiles for the user and/or the animal subject comprising the animal subject information, user information, user authentication credentials and appointment preferences. The system may transform the aforementioned information into searchable and retrievable data and store at least a portion of the data in a memory location associate with the veterinary medicine system for quicker access and data security. In some embodiments, the system may request authentication credentials from the user comprising usernames, passwords, personal identification numbers, biometric information like fingerprint or iris scans and voice recognition, specific gestures, and the like. The system may initiate a session with one or more veterinarians after successful validation of the authentication credentials. In some embodiments, the user authentication credentials may be associated with or linked to the user profile and/or the animal subject profile, such that the user may be enabled to access at least a portion of the previously stored information after the successful validation of the authentication credentials.

As shown in block 220, the process flow 200 may further include retrieving at least a portion of the medical history of the animal subject in response to receiving a request from the user to connect to a veterinary medicine system. In some embodiments, the user may provide at least a portion of the medical history of the animal subject, either prior to or during initiation of the session. The medical history may comprise the animal species/subspecies, breed, age, known allergies, diet, medical history, prior illnesses and medications, prior surgical procedures, vaccinations, symptoms, test results, and the like. In some embodiments, the user may provide the medical history via the user application in a textual form comprising alphanumeric characters, by choosing one or more options presented on the application interface or by any other suitable means. In some embodiments, the user may provide at least a portion of the medical history in an audio form. In this regard, the system may recognize the spoken language and convert/transform the audio input into textual form and/or machine readable language using suitable computational linguistics technologies. In some embodiments, the user may provide at least a portion of the medical history in the form of documents or images of documents. The system my scan the document, capture images of at least a portion of each of the documents and convert the document into electronic image files. Alternatively, the user may upload images of relevant documents. The system may extract and transform the printed/typed and handwritten text of the images into machine-encoded text of a suitable format using intelligent character, word, and/or object recognition algorithms. In some embodiments, the system may determine, or otherwise receive information about prior or current health care providers associated with the animal subject. After receiving the requisite authorization from the user, the system may extract the relevant medical history from servers or systems associated with healthcare or insurance providers of the animal subject. The system may then analyze or parse the received/extracted information, categorize, and store relevant information in a suitable format. In some embodiments, the system may append, update or otherwise modify existing user and/or animal subject profiles and animal subject medical history with the newly received information. In some embodiments, the system may create a timeline for the animal subject and augment the timeline with the received medical history, with medical events and associated event information. For example, the event may be surgery, consultation/sessions with the veterinarian, vaccination, and the like, while the event information may be symptoms, diagnosis, prescribed medication, test results, information provided by the user and/or the veterinarian during the consultation/session, and the like.

The system may further determine a user location as illustrated by block 230, in accordance with some embodiments of the invention. In some embodiments, the system may determine the user location based on retrieving location information and coordinates from user devices comprising GPS and other location determining systems. In some embodiments, the system may determine the user location based on received user information (for example, residential address), retrieved user calendar and future appointments, social media information, activity/financial transaction information, and the like. The system may determine current user location and/or potential future locations.

The process flow includes determining one or more veterinarians associated with the veterinary medicine system based on at least the retrieved medical history and/or the user location as illustrated by block 240. The veterinary medicine system may be associated with a plurality of veterinarians. In this regard, the system may maintain a database of the associated veterinarians and relevant details comprising name, contact information, certifications, geographic area in which the veterinarian is licensed to practice, specialization or areas of focus, practice information (for example, name of institution/entity, location, veterinarian schedule at the location), insurance providers accepted, average wait times, and the like. In some embodiments, the system may also periodically determine the availability of the veterinarians for the most current information, based on accessing the veterinarians' calendars, appointments, and the like. In some embodiments, the system may receive and store user ratings from other users that have previously visited the veterinarians. In some embodiments, the system may determine preferred/sponsored veterinarians/practices based on skill level, patient feedback, experience, and the like. The system may then analyze the veterinarian details along with the animal subject information/medical history, appointment preferences, user information, and user location to determine one or more veterinarians of the plurality of veterinarians that are suitable for the requested session. For example, the system may determine one or more veterinarians that are licensed to practice at the user's location. As another example, the system may determine one or more veterinarians based on determining that the one or more veterinarians are with a predetermined distance from the user location or within a specified geographic area like a city or zip code. As another example, the system may determine that the animal subject is a cow and seek one or more veterinarians that specialize in bovine medicine/treatment. In some instances, the system may choose one or more veterinarians who have previously treated the animal subject. For example, if the user is seeking a follow-up session, the system may determine the one or more veterinarians who were associated with the preceding session. However, in other instances the system may determine other veterinarians. For example, based on analyzing the medical history, the system may determine that the animal subject was previously treated by a first veterinarian for an orthopedic condition, however, the system may determine veterinary dermatology specialists based on determining that the current complaints/illnesses of the animal subject relate to the subject's skin. In some embodiments, the system may determine one or more veterinarians who are available for sessions at the preferred appointment times of the user. In this regard, based on availability of veterinarians, user preference for a particular specialist, estimated duration of session required to address the animal subject's current illness, the system may request the user to provide alternate session times.

The system may then initiate a display of the determined one or more veterinarians of the plurality of veterinarians who are suitable for the user's requested session. The system may additionally display, via the user application, at least a portion relevant details of the one or more veterinarians extracted from the databased as described above. For example the system may display on the user application, an image associated with the veterinarian/the veterinarian's clinic/facility, contact information, certifications/degrees, number of years of experience, geographic area in which the veterinarian is licensed to practice, specialization or areas of focus, practice information (for example, name of institution/entity, location, veterinarian schedule at the location), insurance providers accepted, average wait times, patient feedback/ratings, indication of or information about previous sessions with the veterinarian (date, time, purpose, and the like), and the like. These details may be presented proximate the user name, in a pop-up window, in a table, as a link to another page or any other suitable means and the user may specify the details he/she wishes to see. The system may order the one or more veterinarians based on suitable ordering criteria like previous association/sessions with the animal subject, user ratings, lowest wait times, shortest distance from the user's location, relevant specialization, preferred/sponsored practices, and the like. The user may then select at least one veterinarian for the requested session. Next, in block 250, the process flow includes receiving a selection of at least one veterinarian of the one or more veterinarians from the user via the user system. The system may then notify the at least one veterinarian with details about the requested session (for example, session start time, duration and/or details about the animal subject). After receiving a confirmation from the veterinarian, the system may schedule the session and update the calendars of the user and the at least one veterinarians with the details of the new sessions.

Following a selection of at least one veterinarian by the user, the system establishes a video communication link between the at least one veterinarian and the user device, as illustrated by block 260. In this regard, the system may establish the video communication link between a veterinarian system associated with the at least one veterinarian and the user device, via the veterinarian system. In some embodiments, the system may seek to transmit and store a veterinarian application at the veterinarian system. This may be substantially similar to the installation of the user application at the user device described previously. In some embodiments, the system may establish the video communication link in real-time or in near real-time of receiving the selection from the user. In some embodiments, the system may establish a video communication link at the time of the scheduled session. Next, in block 270, the process flow includes transmitting the medical history of the animal subject to the user device and the at least one veterinarian. In some embodiments, the system may transmit at least a portion of the medical history and information provided by the user about the animal subject to the veterinarian system. For example, the system may transmit the medical history and the created timeline associated with the animal subject. As another example, the system may transmit the current symptoms, current diet, medication, and the like associated with the animal subject that was provided by the user. In some embodiments the system may transmit the medical history a predetermined time before the session to enable the veterinarian to prepare for the session, while in other embodiments, the system may transmit the medical history at the commencement of the session.

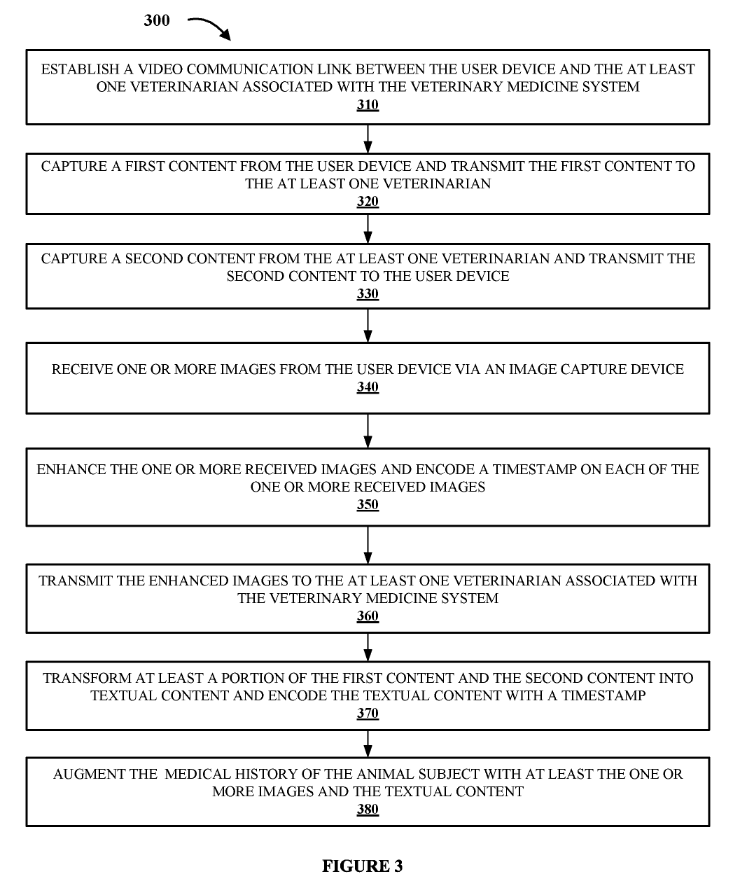

FIG. 3 provides a flowchart illustrating establishing a video communication link between the user device and the at least one veterinarian associated with the veterinary medicine system, in accordance with various embodiments of the invention. Block 310 of FIG. 3 illustrates establishing a video communication link between the user device and the at least one veterinarian associated with the veterinary medicine system. In this regard, the system may establish the video communication link in real-time or at the start time associated with the scheduled session. In some embodiments, the session may take the form of a video chat between the user and the at least one veterinarian, located at separate locations. In this regard, the user may be participating in the session from the user device via the user application, while the at least one veterinarian may engage in the session from the veterinarian system, via the veterinarian application. In some embodiments, the veterinarian application may be similar in structure to the user application. In some embodiments, the veterinarian application is a separate application stored on the veterinarian system, while in other embodiments, the veterinarian application is an interface provided by the veterinary medicine application. In some embodiments, the system may enable voice calls during the session. In some embodiments, the system enables instant messaging via the user application and the veterinarian application. The system may initiate the session on the user device that the user transmitted a session request with, or another suitable user device(s) as discussed earlier. In some embodiments, the user application and/or the veterinarian application always run in the background on their respective devices and are automatically activated at the time of the start of the session. In some embodiments, the system transmits control signals that cause the activation of user application and/or the veterinarian application and cause the applications to present appropriate interfaces to the user and/or the at least one veterinarian respectively. In some embodiments, based on determining that the user device and/or the veterinarian system is offline, the system may transmit text messages, encoded signals via other online devices in proximity, and the like that are configured to activate the applications and cause the devices to connect to the internet or to an appropriate network.

As illustrated by block 320 in FIG. 3, the system captures a first content from the user device and transmits the first content to the at least one veterinarian. As mentioned previously, the session is a real-time session that enables the user and the at least one veterinarian to communicate in real-time or in real-time in an audio visual medium, in accordance with some embodiments of the inventions. Therefore, the system enables the user to engage in a virtual visit to the veterinarian for animal assessment and diagnosis, irrespective of the fact that the user and the at least one veterinarian may be at different locations. In some embodiments, the session may comprise a video chat between the user and the at least one veterinarian, such that the user is able to perceive the at least one veterinarian and/or the veterinarian is able to perceive the user and/or the animal subject, in real-time or near real-time. In this regard “perception” may refer to being able to see, view and/or hear, which may be achieved by capturing and transmitting live audio/video at the user device and/or the veterinarian system. The system enables remote assessment and treatment of the animal subject, since the at least one veterinarian is enabled to examine the animal subject, albeit the animal subject and/or the veterinarian may be at remote locations and/or are unable to travel. In some embodiments, the first content captured from the user device may comprise audio, video and tactile information captured from the user device. In this regard, in some embodiments, system may transmit control instructions to the primary user device(s), the secondary user devices, the auxiliary devices and/or other external devices, configured to cause the devices to capture at least a portion of the first content. In some embodiments, at least a portion of the first content may be captured at discrete time intervals, or in other embodiments, at least a portion of the first content may be captured continuously to provide live feeds. In some embodiments, the first content captured from the user device is transformed, encoded, edited, enhanced or otherwise processed, before and/or after transmission to another system.

The user interface provided by the user application of the user device may comprise of one or more graphical elements like dashboards, pop-up screens, windows, images, videos, sound clips, action buttons, drop down menus, toggle screens, text boxes, and the like. In some embodiments, the interface may suitably display audio-visual and textual content. The veterinarian application may be substantially similar to the user application described above, however, in some embodiments, the system may provide additional tools, information, and functionality to the veterinarian interface to aid in the examination, diagnosis and treatment of the animal subject. In some embodiments, at least a portion of the veterinarian interface may display the first content received from the user device, either in the format that it was received or after converting/transforming the first content to a suitable format. In some embodiments, the system initiates a display of at least a portion of the medical history of the animal subject on the user device and/or the veterinary medicine system. In some embodiments, the medical history, and/or the medical time line provided on the veterinarian application interface may be more detailed or may comprise additional content, in comparison with the medical history provided on the user application interface. For example, the at least one veterinarian may be provided with medical notes entered during previous sessions, may be provided with medical and diagnostic tools and information from veterinary medical databases, and the like. In some embodiments, the system enables the at least one veterinarian to connect other veterinarians, associated with the veterinary medical systems, to participate in the session via other veterinarian systems, to help aid in the diagnosing, treatment or care of the animal subject.

In some embodiments, the first content comprises, at least in part, animal subject information provided by the user. The animal subject information may comprise general information concerning the animal subject, for example, the animal species/subspecies, breed, age, known allergies, diet, and the like. Although in some embodiments, the system may retrieve the medical history of the animal subject and display the history on the veterinarian system, in other embodiments, the user may provide the medical history as a part of the first content or provide additional details about the medical history as a part of the first content. The animal subject information may further comprise current information about the animal subject like current medication, current symptoms, observed changes in behavior, health complaints/illness, known allergies, sensitivity to anesthesia, and the like. In some embodiments, the user may provide at least a portion of the first content in response to a request from the at least one veterinarian.

In some embodiments, the user may provide at least a portion of the in an audio form. For example, the user may merely speak aloud the first content described above, which may be captured by a microphone. The first content may then comprise a video of the user speaking (captured by an image capturing device), synchronous with the audio from the speech. The preferably synchronous audio visual content may be transmitted to the veterinarian system. The at least one veterinarian may view the user and listen to the speech, discern the content of the speech and respond to the user appropriately either by speaking, typing, using gestures or by any suitable form. In some embodiments, the user and/or the veterinarian may articulate in an audio visual form to therefore participate in a conversation.

In some embodiments, the system may recognize the spoken language and convert/transform the conversation of the user and/or the veterinarian into textual form, another suitable audio form, visual representation, and the like, using suitable computational linguistics technologies. For instance, the system may convert the conversation to textual form for storing and updating the animal subject's medical records/history. As another example, the veterinarian may not be fluent in or may not recognize the language spoken by the user and vice versa. In this regard, the system may extract the audio from the first content, discern words, phrases, sentences, and the like, and translate them into a language specified by the user/veterinarian. The translated content may be presented in a textual form or using a visual representation or converted back into audio form in the translated language for presentation. In this regard, the system may utilize linguistic databases, audio recordings, and the like.

In another aspect, the invention enables users with disabilities like visually impaired users, speech impaired users and hearing impaired users to access health care for animal subjects associated with them. For example, the users may be associated with pets/animal subjects that aid them with their disability like guide dogs, Seeing Eye dogs, hearing dogs, and the like. Speech impaired users may communicate with sign language or gestures that may not be comprehensible to the at least one veterinarian. In this regard, the system may analyze the video of the first content, assign control points to the images of the user's hands, limbs and face and recognize the gestures and signs based on determining the movement of the control points relative to each other. For example, the system may assign control points at the fingers and palm of the user, determine their relative positions either constantly or intermittently and recognize words/letters of a sign language. The system may then convert the recognized words to a suitable format before transmitting the first content to the at least one veterinarian. The system may assist the hearing impaired users by providing content in a visual format or suitably enhanced audio format. The system may assist the visually impaired users by converting content in an audio format and suitably presenting the content via the user device, or by enabling the user to provide the first content in a tactile format, like gestures on a touch screen, Braille symbols, and the like and converting them to a suitable format.

Block 330 illustrates capturing a second content from the at least one veterinarian and transmitting the second content to the user device. The second content may be similar in structure and function to the first content described above. The second content may be suitably displayed on the user interface. The second content may comprise the portion of the conversation provided by the at least one veterinarian. In some embodiments, the second content may comprise queries, comments, diagnosis, and description of treatment regimes, prescribed medication, and the like.

Block 340 of FIG. 3 illustrates receiving one or more images from the user device via the image capture device. In some embodiments, the at least one veterinarian may seek to visually perceive the animal subject as a part of the examination, for example to look for signs of skin abnormalities, pupil dilation, oral symptoms, to gauge the general demeanor of the animal subject, muscle tone, and the like. In this regard, based on the input form the veterinarian, the system may transmit control instructions to the direct the image capture device toward the animal subject, to focus or zoom in on certain areas in some embodiments, while in other embodiments the user may position/operate the image capture device appropriately. In some embodiments, the images received are video images which may also be accompanied by an audio stream, while in other embodiments the images are still images. Therefore, the veterinarian, at a location away from the animal subject is enabled to examine the animal. In some embodiments, the one or more images may be a part of the first user content. While the one or more images may be captured and transmitted in real-time, the one or more images may also be captured by the user in advance and transmitted to the veterinarian system.

In response, the process flow includes enhancing the one or more received images and encoding a time-stamp on each of the one or more received images, as illustrated by block 350. In this regard, in some embodiments, the system may enhance the resolution, color hue, brightness, sharpness and other features of the image and eliminate distortions, to enable the at least one veterinarian to analyze/examine the one or more images easily. In some embodiments the system may enable the at least one veterinarian to modify the features of the one or more images like size (increase, decrease, crop), layers (positioning, altering, stacking and blending individual layers), orientation (change orientation of the image itself and the objects within the image), color, view, perspective, and the like, or the system may perform one or more of the above. The system may encode the image files of the one or more images or associate the one or more images with a time-stamp. The time-stamp may indicate the date and time associated with when the images were captured, when they were received at the system and/or when the images were transmitted to the veterinarian system. The system may augment the medical history/timeline of the animal subject with one or more images comprising the associated time-stamps. This time-stamping may aid the user and/or the veterinarian for future sessions. For example the animal subject may be suffering from a skin ailment, and the veterinarian may wish to determine the progress of the condition or improvement due to medication over a period of 6 months. The system may then easily extract the pertinent images with time-stamps falling in that period. Next, as shown in block 360, the system may transmit the enhanced images to the at least one veterinarian associated with the veterinary medicine system. Typically, the at least one veterinarian may examine the one or more images before providing the diagnosis or treatment as a part of the second content.

After the session or during the session, the system may transform at least a portion of the first content and the second content into textual content and encode the textual content with a time-stamp, as illustrated by block 370 in FIG. 3. As such, the transformation of the first content and the second content into text may be similar to the transformation described previously. For example, the system may recognize the content of the conversation (first and second content) between the user and the at least one veterinarian, convert the conversation to text and/or machine readable language and time-stamp each exchange of the conversation. The system may then analyze the content and extract portions of the conversation that are relevant/pertinent to the animal subject's health concerns, for example, the symptoms described by the user, the diagnosis provided by the veterinarian, the medication prescribed by the veterinarian, and the like. As illustrated by block 380, the system may augment the medical history of the animal subject and session data with the at least the one or more images and the relevant portions of the first and second content. In some embodiments, the system may assign unique identifiers to the session, to the animal subject, to the veterinarian and/or to the user and encode the image and text files with the identifier to effectively categorize the storage and for ease of retrieval. In this regard, the system may employ digital data compression and other suitable techniques, to reduce the size of the images and text files before storage for efficient memory utilization.

FIG. 4 provides a flowchart illustrating connecting one or more auxiliary devices to the veterinary medicine system, in accordance with various embodiments of the invention. Block 410 in FIG. 4 illustrates retrieving application information from the user device to determine one or more auxiliary devices that are currently connected to the user device or that have been previously connected to the user device. The application information may comprise one or more applications and widgets stored on the user device, information regarding the type of device and device identifiers (for example, unique device identifiers), information regarding the entities associated with the application (application owner/provider, type of authentication required, and the like), devices that the applications/widgets are configured to control (cameras, GPS systems, auxiliary devices, sensors and other internal and external devices), connection history, usage patterns and frequency of use, location of storage of the applications/widgets, and the like. The auxiliary devices are configured to determine one or more diagnostic parameters associated with the animal subject. The diagnostic parameters may comprise physical parameters of the animal subject that may aid in diagnosis like heart beat/pulse, blood pressure, heart rate, body temperature, respiratory rate, movement/exercise/activity levels, location, body position, calories consumed and/or spent, and the like. In some embodiments, auxiliary devices may comprise wearable devices that are configured to be adorned by the animal subject, placed or secured at a suitable location on the animal subject's anatomy, that are configured to be implanted in the animal subject and that are configured to be otherwise affixed to or associated with the animal subject, either for continuously, for extended periods of time or may be affixed when measurement of diagnostic parameters is required. While in some embodiments, the auxiliary devices are wearable devices that are configured to determine the diagnostic parameters on the basis of their proximity/contact with the animal subject, other embodiments may comprise auxiliary devices that may be configured to measure the diagnostic parameters without being in contact with the animal subject. In this regard, the auxiliary devices may be configured to determine the diagnostic parameters based on visual examination of the animal subject and/or discerning the animal subject's interaction with sound waves, electromagnetic waves, X-rays, and the like. The auxiliary devices may comprise one or more sensors to determine the diagnostic parameters either constantly or intermittently. In some embodiments the auxiliary devices may be controlled using an application/widget stored on the user device or the diagnostic parameters measured may be viewed/monitored via the application. The auxiliary devices may me owned by the user, the veterinary medicine system or a third party entity. The auxiliary devices may be controlled using the user application or one or more third-party application. Therefore, the invention enables effective and functional integration and adaptation of external or third-party devices and systems.

The system may analyze the application information to determine one or more auxiliary devices that are currently connected to the user device or have been previously connected to the user device. For example, the system may recognize that an application controlling a wearable temperature sensor is stored on one or more user devices and therefore determine that the user/animal subject is associated with an auxiliary device, i.e., the wearable temperature sensor. Alternatively, or in addition the system may analyze the user's transaction history, social media information, and the like to determine auxiliary devices. For example the system may determine that the user purchased a veterinary fitness tracker or the system may determine that the user/animal subject is associated with a wearable device based on analyzing images or social media updates of the user. In some embodiments, the system initiates a display of determined auxiliary devices and receive a user selection of the auxiliary devices that the user wishes to include in the session with the at least one veterinarian. In some embodiments, the system may enable the user to provide an input comprising one or more auxiliary devices that the user wishes to include in the session with the at least one veterinarian, as illustrated by block 420. In this regard, the user may provide auxiliary device identifiers, information about the associated entity, associated application, and the like to enable the user to recognize and control the auxiliary device.

As illustrated by block 430 in FIG. 4, the system establishes communication links with each of the one or more auxiliary devices. In some embodiments, the system may establish communication links with the one or more auxiliary devices via the associated applications on the user device, while the system may establish direct communication links in other embodiments. In this regard, the user may provide the requisite authorization and/or authentication credentials to enable the system to connect to, monitor and control the one or more auxiliary devices and/or the associated applications. In some embodiments, following the linking of the auxiliary devices, the system may analyze the applications associated with the auxiliary devices and/or the signals transmitted by the auxiliary devices to determine the type and frequency of the diagnostic parameters measured. In some embodiments, the system may retrieve the historical diagnostic parameters that were measured over a period of time. In some embodiments, the system may constantly/periodically monitor the current diagnostic parameters, store the parameters at a suitable memory location for ease of retrieval during the session. In some embodiments, the system may store at least a portion of the diagnostic parameters as a part of the medical history of the animal subject. In some embodiments the system enables the user to monitor and control the one or more auxiliary devices via the user application of the user device. In some embodiments, the system may determine optimal threshold values for each of diagnostic parameters, based on the animal subject species, age, and the like. In some embodiments, the system may receive the threshold values from the user and/or the at least one veterinarian. The optimal threshold values may comprises an upper limit, a lower limit or a range of acceptable values. In some embodiments, the system may constantly/periodically monitor the diagnostic parameters and determine of the current values of the diagnostic parameters exceed the threshold value, therefore providing proactive and dynamic healthcare for the animal subject in real-time. The system may determine a trigger event when the current values of the diagnostic parameters deviate from the threshold value. In response to the trigger event the system may alert the user via the user application, on the user device via notifications, emails, text messages, or any other suitable means. In some embodiments in response to the trigger event, the system may transmit at least a portion of the pertinent diagnostic parameters to the veterinarian system and initiate a session to address the heath of the animal subject.

As illustrated by block 440, the system may determine whether the animal subject is currently associated with the one or more auxiliary devices. In some embodiments, the system may analyze the signals transmitted by the auxiliary devices and/or the applications associated with the auxiliary devices to determine whether the animal subjects are currently associated or in contact with the device or whether the auxiliary device is currently measuring the parameters. In response the system may transmit control signals to turn on the auxiliary devices and configure the devices to transmit the measured diagnostic parameters. Block 450 of FIG. 4 illustrates that the system transmits control instructions to the one or more auxiliary devices that cause the one or more auxiliary devices to transmit diagnostic parameters associated with the animal subject. Alternatively, the system may transmit requests to the user to connect/associate the auxiliary device with the animal subject and/or configure the auxiliary devices to measure and transmit the diagnostic parameters. In some embodiments, the at least one veterinarian may transmit requests to receive diagnostic parameters associated with the animal subject, via the veterinarian application during a session. In this regard, the system may retrieve diagnostic parameters from the auxiliary devices based on the type of parameter, required time period of parameters and specific auxiliary devices as specified by the veterinarian, or the system may enable the at least one veterinarian to access the application associated with the auxiliary device or the stored historical diagnostic parameters.

As illustrated by block 460 in FIG. 4, the system may then transform the received parameters into a suitable form and display the parameters on the veterinary medicine system and the user device. In some embodiments, the diagnostic parameters received from the auxiliary device may be in a first format, for example in binary format, machine language, encoded in electromagnetic signals, and the like. In this regard, the system may decode the parameters and transform the parameters into a second format: alphanumeric format, decimal numbers or another suitable format recognizable by the veterinarian. In some embodiments, the system may convert the parameters to appropriate units, generate graphs, and visual representation of the received data as specified by the at least one veterinarian.

FIG. 5 provides a flowchart illustrating enabling preventative, diagnostic or treatment related functions, in accordance with an embodiment of the present invention. As illustrated by block 510, the system enables the at least one veterinarian associated with the veterinary medicine system to perform preventative, diagnostic or treatment related functions. These functions may comprise receiving symptoms and complaints of the animal subject, analyzing the medical history of the animal subject, examining the animal subject, analyzing diagnostic parameters, diagnosing the condition, determining treatment and medication, and the like. Block 520 illustrates that the system may receive session data associated with the diagnostic session of the animal subject. The session data may comprise the first content provided by the user, on or more images of the animal subject, second content provided by the veterinarian, diagnostic parameters retrieved during the session, and the like. Receiving the aforementioned session data has been described in detail throughout the specification, and in particular with respect to process flows 300 and 400. Block 530 illustrates that the system may receive session data comprising a diagnosis, treatment and/or a medical prescription from the at least one veterinarian associated with the veterinary medicine system. The system may determine the medication prescribed by the at least one veterinarian, determine composition of the medication, dosage, required quantities and specific brands, if any. As illustrated in block 540, the system may display at least a portion of the diagnosis, treatment and/or medical prescription, received from the at least one veterinarian on the user device in a suitable format.

Next, as shown in block 550, the process flow includes determining one or more pharmacies based on the user location and the user transaction history, and determine an estimated delivery/pickup time for each of the one or more pharmacies. In some embodiments, the system may determine the user location based on retrieving location information and coordinates from user devices comprising GPS and other location determining systems. In some embodiments, the system may determine the user location based on received user information (for example, residential address), retrieved user calendar and future appointments, social media information, activity/financial transaction information, and the like. The system may determine current user location and/or potential future locations. The system may then determine one or more pharmacies that are within a predetermined distance from the user location or within a specified geographic area like a city or zip code. The system may then ascertain whether the prescribed medication and the required quantities are available at the one or more pharmacies. In some embodiments, the system may determine one or more pharmacies that provide delivery of the medication to the user's location. In this regard, in addition to determining availability of the prescribed medication, the system may also determine delivery times and choose pharmacies based on determining that the medication may be delivered within the start time of the dosage as prescribed by the at least one veterinarian. The system may display the determined at least one pharmacy on the user application interface. Additional information associated with the pharmacies comprising locations, estimated travel time, total estimated price for medication, cost of shipping, estimated delivery time, and the like may also be displayed on the user interface. In some embodiments, the system may also order the pharmacies based on the lowest price, earliest delivery date, shortest distance for pickup, and the like. In response, the process flow includes receiving a selection of at least one pharmacy from the user and transmitting an order associated with the medical prescription as shown in block 560. After receiving a selection of at least one pharmacy from the user, the system may enable the user to modify the medication, add one or more products, specify pickup or delivery time, provide payment information, and the like. The system may then generate an order based on the user input and transmit the order along with the prescription form the veterinarian to the at least one pharmacy.

Next, as shown in block 570, the process flow includes analyzing the session data and determining one or more potential follow-up treatment sessions associated with the animal subject. In this regard, the system may analyze the session data, for example, the session data converted to text or machine readable form, and determine potential follow-up sessions. For example, the system may analyze the conversation between the user and the at least one veterinarian and determine that the veterinarian indicated that another session after two weeks would be beneficial. The system may then determine a suitable appointment time for two weeks after the session based on determining overlapping/matching the times of availability of the at least one veterinarian and the user. In this regard the system may access the user's and the veterinarian's appointments, calendaring applications, and the like. The system may then transmit proposed follow-up sessions to the user and receive a selection of one or more appointments. The follow-up session may be similar to the session described above. In some embodiments, based on determining changes in availability of the user and/or the veterinarian, the system may dynamically update existing follow-up session appointment or propose new appointment times. Next, as illustrated by block 580, the system may insert the one or more appointments associated with the follow-up treatment sessions in an appointment calendaring application associated with the user device. The system may further update the calendar of the at least one veterinarian with the one or more appointments.

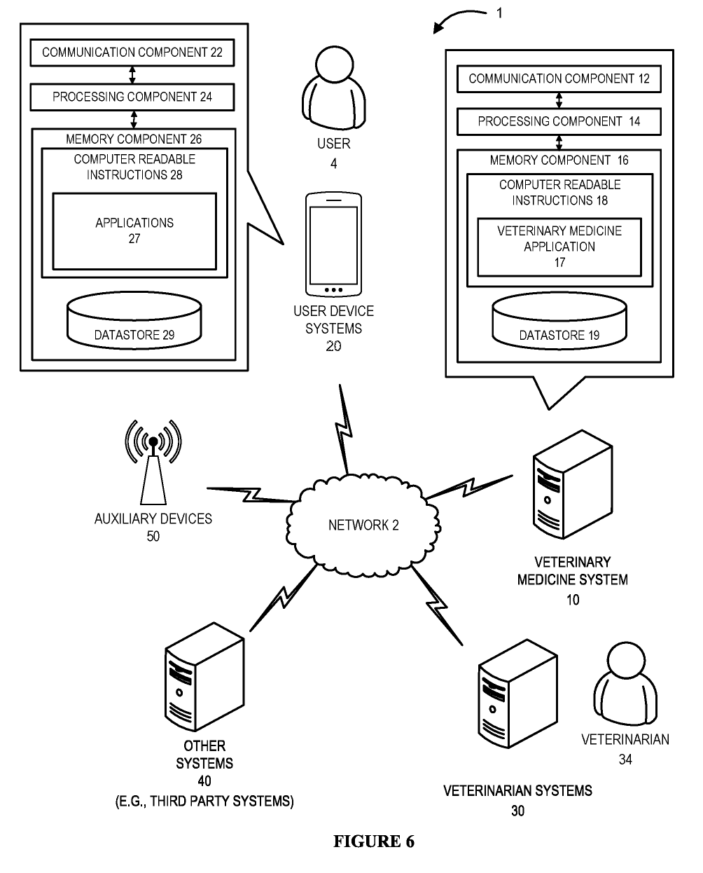

FIG. 6 illustrates a veterinary medicine system environment 1, in accordance with embodiments of the invention. As illustrated in FIG. 6, the veterinary medicine system 10 is operatively coupled, via a network 2, to one or more user device systems 20, one or more veterinarian systems 30, one or more other systems 40, and/or one or more auxiliary devices 50. In this way, the user 4 (associated with the animal subject) may allow the veterinary medicine application 17 to take actions and/or utilize the veterinary medicine application 17 to communicate with (e.g., send or receive data from, control, or the like) the user applications 27 and/or the veterinarian systems 30 associated with one or more veterinarians 34. The veterinary medicine application 17 may utilize the network 2 to communicate with user applications 27 on the user device systems 20, veterinarian applications on the veterinarian systems 30, other applications on other systems, or specific auxiliary devices 50.

In some embodiments of the invention the veterinary medicine system 10 may monitor, store, and provide information related to applications 27 and auxiliary devices 50 discussed herein in order to help the veterinarian 34 in performing preventative, diagnostic or treatment related functions directed towards the health of the animal subject.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 6, the veterinary medicine system 10 generally comprises one or more communication components 12, one or more processing components 14, and one or more memory components 16. The one or more processing components 14 are operatively coupled to the one or more communication components 12 and the one or more memory components 16. As used herein, the term “processing component” generally includes circuitry used for implementing the communication and/or logic functions of a particular system. For example, a processing component 14 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components 14 may include functionality to operate one or more software programs based on computer-readable instructions 18 thereof, which may be stored in the one or more memory components 16.

The one or more processing components 14 use the one or more communication components 12 to communicate with the network 2 and other components on the network 2, such as, but not limited to, the user device systems 20, the veterinarian systems 30, other systems 40 (e.g., third-party systems, or the like), and/or auxiliary devices 50. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors, and the like.

As further illustrated in FIG. 6, the veterinary medicine system 10 comprises computer-readable instructions 18 stored in the memory component 16, which in one embodiment includes the computer-readable instructions 18 of a veterinary medicine application 17. In some embodiments, the one or more memory components 16 include one or more datastores 19 for storing data related to the veterinary medicine system 10, including, but not limited to, data created, accessed, and/or used by the veterinary medicine application 17, first content, second content, session data, veterinarian database, animal subject medical history and user profile.

The veterinary medicine application 17 may be a tool, website, mobile device app, other computer system app, applet, combinations or multiples thereof, or the like that is used to take the actions discussed throughout the specification. For example, the veterinary medicine application 17 transmits and stores a user application 27 on the user device 20, receives requests from the user 4 to connect to the veterinary medicine system 10, established a video communication link between the user device 20 and the veterinary medicine system 10 and/or the veterinarian systems 30, enables transfer of textual, audio and video communication via the communication link, enables the user 4 to connect one or more veterinarians associated with the veterinary medicine system to perform preventative, diagnostic and treatment related functions and configures the textual, audio and video communication for future user, as discussed throughout this application.

As illustrated in FIG. 6, users 4 may access the user application 27, veterinary medicine application 17, or other applications, through a user computer system 20. The user computer system 20 may be a desktop, laptop, tablet, mobile device (e.g., smartphone device, or other mobile device), or any other type of computer that generally comprises one or more communication components 22, one or more processing components 24, and one or more memory components 26.

The one or more processing components 24 are operatively coupled to the one or more communication components 22, and the one or more memory components 26. The one or more processing components 24 use the one or more communication components 22 to communicate with the network 2 and other components on the network 2, such as, but not limited to, the veterinary medicine system 10, the veterinarian systems 30, the other systems 40, and/or the other auxiliary devices 50, which may or may not be specifically illustrated and/or otherwise described herein. As such, the one or more communication components 22 generally comprise a wireless transceiver, modem, server, electrical connection, or other component for communicating with other components on the network 2. The one or more communication components 12 may further include an interface that accepts one or more network interface cards, ports for connection of network components, Universal Serial Bus (USB) connectors, and the like. Moreover, the one or more communication components 22 may include a keypad, keyboard, touch-screen, touchpad, microphone, mouse, joystick, other pointer component, button, soft key, and/or other input/output component(s) for communicating with the users 4.

As illustrated in FIG. 6, the user device systems 20 may have computer-readable instructions 28 stored in the one or more memory components 26, which in one embodiment includes the computer-readable instructions 28 of applications 27, such as dedicated applications (e.g., apps, applet, or the like), portions of dedicated applications, web browser or other apps that allow access to applications located on other systems, or the like. The applications 27 may include any type of application that the user may utilize, such as but in no way limited to, a veterinary medicine application (user application), an appliance application, a wearable device application, a shopping application, a financial account application, a budgeting application, media application, social media application, exercise application, or any other type of application which may or may not be explicitly discussed herein. It should be understood that some of the applications 27 may be associated with and control the auxiliary devices 50, or the applications 27 may be separate from specific dedicated auxiliary devices 50, or may be a combination thereof (e.g., some applications 27 related to and used for controlling the auxiliary devices 50, and some applications that are unrelated to the auxiliary devices 50).

As illustrated in FIG. 6, the veterinarian systems 30 are operatively coupled to the veterinary medicine system 10, user device systems 20, other systems 40, or the like, through the network 2. The veterinarian systems 30 have components the same as or similar to the components described with respect to the veterinary medicine system 10 and/or user device systems 20 (e.g., one or more communication components, one or more processing components, and one or more memory devices with computer-readable instructions of one or more applications, one or more datastores, or the like). Thus, the veterinarian systems 30 communicate with the veterinary medicine system 10, the user device systems 20, and the other systems 40, and/or each other in same or similar way as previously described with respect to the veterinary medicine system 10 and/or the user device systems 20. The veterinarian systems 30, in some embodiments, may include separate systems, each system being associated with at least one veterinarian 34 related to the veterinary medicine system 10.

The other systems 40 (e.g., other pharmacy systems, other insurance and healthcare provider systems, financial institution systems, merchant systems, social networking systems, systems associated with the auxiliary devices 50, systems associated with the applications 27 on the user device systems 20, or the like) are operatively coupled to the veterinary medicine system 10, user device systems 20, and veterinarian systems 30, through the network 2. The other systems 40 have components the same as or similar to the components described for the financial institution systems 10 and the user device systems 20 (e.g., one or more communication components, one or more processing components, one or more memory components with computer-readable instructions, one or more applications stored in the one or more memory components, one or more datastores, or the like). Thus, the other systems 40 communicate with the veterinary medicine system 10, the user device systems 20, and the veterinarian systems 30, and/or each other in the same or similar way as previously described with respect to the veterinary medicine system 10, the user device systems 20, and/or the veterinarian systems 30. The other systems 40, in some embodiments, provide the information to facilitate the real-time veterinarian communication linkage for animal assessment and diagnosis.

The auxiliary devices 50 (e.g., as described with respect to FIGS. 2 and 3, or the like) are operatively coupled to the veterinary medicine system 10, user device systems 20, and veterinarian systems 30, through the network 2. The auxiliary devices 50 have components the same as or similar to the components described for the financial institution systems 10 and the user device systems 20 (e.g., one or more communication components, one or more processing components, one or more memory components with computer-readable instructions, one or more applications stored in the one or more memory components, one or more datastores, or the like) and/or one or more specific components like sensors, transmitters, microprocessors, and the like, to measure, monitor and transmit the diagnostic parameters of the animal subject. Thus, the auxiliary devices 50 communicate with the veterinary medicine system 10, the user device systems 20, the veterinarian systems 30, other systems 40, and/or each other in the same or similar way as previously described with respect to the veterinary medicine system 10, the user device systems 20, the veterinarian systems 30, and/or the other systems 40.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and Blu-Ray disc where disks usually reproduce data magnetically, while discs usually reproduce data optically with lasers. Combinations of the above should also be included within the scope of computer-readable media.

As will be appreciated by one of skill in the art in view of this disclosure, embodiments of the invention may be embodied as an apparatus (e.g., a system, computer program product, and/or other device), a method, or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the invention described above, with reference to flowchart illustrations and/or block diagrams of methods or apparatuses/systems (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus configured for real-time veterinarian communication linkage for animal assessment and diagnosis, the apparatus comprising:
a non-transitory computer-readable storage medium including computer-readable program code stored therein;
a processor operatively coupled to the computer readable storage medium and configured to execute the computer readable program code to:
establish an operative communication link with a user device associated with a user, the user being associated with an animal subject;
receive, via the operative communication link, a request from the user to initiate a veterinary medicine session;
determine one or more veterinarians associated with a veterinary medicine system and transmit information associated with the one or more veterinarians to the user device;
receive, via the operative communication link, a selection of at least one veterinarian of the one or more veterinarians from the user;
establish a video communication link between a veterinarian system associated with the at least one veterinarian and the user device;
initiate a real-time veterinary medicine session between the user and the at least one veterinarian associated with the veterinary medicine system, wherein initiating the veterinary medicine session further comprises:
capturing a first content from the user device and transmitting the first content to the at least one veterinarian, wherein the first content comprises symptoms of the animal subject;
enabling the at least one veterinarian to perform preventative, diagnostic or treatment related functions; and
capturing a second content from the veterinarian system and transmitting the second content to the user, wherein the second content comprises a diagnosis and a prescribed medication associated with the animal subject; and
close the video communication link and configure the first content and the second content for future storage and retrieval.

2. The apparatus of claim 1, wherein determining the one or more veterinarians associated with a veterinary medicine system, further comprises:
retrieving at least a portion of a medical history associated with the animal subject;
determining a user location;
determining the one or more veterinarians of a plurality of veterinarians associated with the veterinary medicine system based on at least the retrieved medical history and the user location; and
transmitting the retrieved medical history to the veterinarian system associated with the at least one veterinarian of the one or more veterinarians, selected by the user.

3. The apparatus of claim 1, wherein the first content and the second content comprise at least one of textual content, audio content and video content.

4. The apparatus of claim 1, wherein the processor is further configured to:
receive, via the operative communication link, one or more images from the user device via an image capture device;
enhance each of the one or more images, wherein enhancing each of the one or more images further comprises at least one of enhancing a resolution of the image, enhancing sharpness of the image, modifying layers of the image and eliminating distortions;
encode a time-stamp on each of the one or more enhanced images; and
transmit the one or more images comprising the time-stamp to the veterinarian system associated with the at least one veterinarian.

5. The apparatus of claim 1, wherein the processor is further configured to:
retrieve, via the operative communication link, application information from the user device;
determine a first portion one or more auxiliary devices that are currently connected to the user device or that have been previously connected to the user device, based on analyzing the application information, wherein the one or more auxiliary devices are configured to determine one or more diagnostic parameters associated with the animal subject;
receive, via the operative communication link, a second portion of the one or more auxiliary devices from the user;
transmit control instructions to the one or more auxiliary devices that cause the one or more auxiliary devices to transmit the one or more diagnostic parameters associated with the animal subject; and
transform the one or more diagnostic parameters into a second format and display the one or more parameters on the veterinarian system and the user device.

6. The apparatus of claim 1, wherein configuring the first content and the second content for future storage and retrieval further comprises, augmenting a medical history of the animal subject with the first content and the second content.

7. The apparatus of claim 1, wherein the processor is further configured to:
receive, from the veterinarian system, second content comprising the prescribed medication associated with the animal subject;
determine one or more pharmacies based on at least the prescribed medication and a determined user location;
receive, via the operative communication link, a selection of at least one pharmacy of the one or more pharmacies from the user; and
transmit an order associated with the prescribed medication to the at least one pharmacy.

8. The apparatus of claim 1, wherein transmitting information associated with the one or more veterinarians to the user device further comprises:
determining an ordering criteria for a display of the determined one or more veterinarians on the user device, wherein the ordering criteria comprises previous sessions with the animal subject, lowest wait time, shortest distance from a user location and relevant veterinary specialization; and
initiating the display of the one or more veterinarians on the user device based on the determined order, wherein initiating the display of the one or more veterinarians further comprises displaying one or more veterinarian details chosen from a group comprising: an image associated with the veterinarian, contact information, certifications, specialization, number of years of experience, accepted insurance providers and average wait times.

9. A method for real-time veterinarian communication linkage for animal assessment and diagnosis, the method comprising:
establishing an operative communication link with a user device associated with a user, the user being associated with an animal subject;
receiving, via the operative communication link, a request from the user to initiate a veterinary medicine session;
determining one or more veterinarians associated with a veterinary medicine system and transmit information associated with the one or more veterinarians to the user device;
receiving, via the operative communication link, a selection of at least one veterinarian of the one or more veterinarians from the user;
establishing a video communication link between a veterinarian system associated with the at least one veterinarian and the user device;
initiating a real-time veterinary medicine session between the user and the at least one veterinarian associated with the veterinary medicine system, wherein initiating the veterinary medicine session further comprises:
capturing a first content from the user device and transmitting the first content to the at least one veterinarian, wherein the first content comprises symptoms of the animal subject;
enabling the at least one veterinarian to perform preventative, diagnostic or treatment related functions; and
capturing a second content from the veterinarian system and transmitting the second content to the user, wherein the second content comprises a diagnosis and a prescribed medication associated with the animal subject; and
closing the video communication link and configure the first content and the second content for future storage and retrieval.

10. The method of claim 9, wherein determining the one or more veterinarians associated with a veterinary medicine system, further comprises:
retrieving at least a portion of a medical history associated with the animal subject;
determining a user location;
determining the one or more veterinarians of a plurality of veterinarians associated with the veterinary medicine system based on at least the retrieved medical history and the user location; and
transmitting the retrieved medical history to the veterinarian system associated with the at least one veterinarian of the one or more veterinarians, selected by the user.

11. The method of claim 9, wherein the first content and the second content comprise at least one of textual content, audio content and video content.

12. The method of claim 9, wherein the method further comprises:
receiving, via the operative communication link, one or more images from the user device via an image capture device;
enhancing each of the one or more images, wherein enhancing each of the one or more images further comprises at least one of enhancing a resolution of the image, enhancing sharpness of the image, modifying layers of the image and eliminating distortions;
encoding a time-stamp on each of the one or more enhanced images; and
transmitting the one or more images comprising the time-stamp to the veterinarian system associated with the at least one veterinarian.

13. The method of claim 9, wherein the method further comprises:
retrieving, via the operative communication link, application information from the user device;
determining a first portion one or more auxiliary devices that are currently connected to the user device or that have been previously connected to the user device, based on analyzing the application information, wherein the one or more auxiliary devices are configured to determine one or more diagnostic parameters associated with the animal subject;
receiving, via the operative communication link, a second portion of the one or more auxiliary devices from the user;
transmitting control instructions to the one or more auxiliary devices that cause the one or more auxiliary devices to transmit the one or more diagnostic parameters associated with the animal subject; and
transforming the one or more diagnostic parameters into a second format and display the one or more parameters on the veterinarian system and the user device.

14. The method of claim 9, wherein configuring the first content and the second content for future storage and retrieval further comprises, augmenting a medical history of the animal subject with the first content and the second content.

15. The method of claim 9, wherein the method further comprises:
receiving, from the veterinarian system, second content comprising the prescribed medication associated with the animal subject;
determining one or more pharmacies based on at least the prescribed medication and a determined user location;
receiving, via the operative communication link, a selection of at least one pharmacy of the one or more pharmacies from the user; and
transmitting an order associated with the prescribed medication to the at least one pharmacy.

16. The method of claim 9, wherein transmitting information associated with the one or more veterinarians to the user device further comprises:
determining an ordering criteria for a display of the determined one or more veterinarians on the user device, wherein the ordering criteria comprises previous sessions with the animal subject, lowest wait time, shortest distance from a user location and relevant veterinary specialization; and
initiating the display of the one or more veterinarians on the user device based on the determined order, wherein initiating the display of the one or more veterinarians further comprises displaying one or more veterinarian details chosen from a group comprising: an image associated with the veterinarian, contact information, certifications, specialization, number of years of experience, accepted insurance providers and average wait times.

17. An apparatus configured for real-time veterinarian communication linkage for animal assessment and diagnosis, the apparatus comprising:
a non-transitory computer-readable storage medium including computer-readable program code stored therein;
a processor operatively coupled to the computer readable storage medium and configured to execute the computer readable program code to:
establish an operative communication link with a user device associated with a user, the user being associated with an animal subject;
receive, via the operative communication link, a request from the user to initiate a veterinary medicine session;
determine at least one veterinarian associated with a veterinary medicine system;
establish a video communication link between a veterinarian system associated with the at least one veterinarian and the user device;
retrieve, via the operative communication link, application information from the user device;
determine one or more auxiliary devices that are configured to determine one or more diagnostic parameters associated with the animal subject;
initiate a real-time veterinary medicine session between the user and the at least one veterinarian associated with the veterinary medicine system, wherein initiating the veterinary medicine session further comprises:
capturing a first content from the user device and transmitting the first content to the at least one veterinarian, wherein the first content comprises symptoms of the animal subject;
receiving, one or more images from the user device via an image capture device;
enhancing each of the one or more images, wherein enhancing each of the one or more images further comprises at least one of enhancing a resolution of the image, enhancing sharpness of the image, modifying layers of the image and eliminating distortions;
encoding a time-stamp on each of the one or more enhanced images and transmitting the one or more images to the veterinarian system;
transmitting control instructions to the one or more auxiliary devices, that cause the one or more auxiliary devices to transmit the one or more diagnostic parameters associated with the animal subject and transmitting the received diagnostic parameters to the veterinarian system;
enabling the at least one veterinarian to perform preventative, diagnostic or treatment related functions; and
capturing a second content from the veterinarian system and transmitting the second content to the user, wherein the second content comprises a diagnosis and a prescribed medication associated with the animal subject; and
close the video communication link and configure the first content and the second content for future storage and retrieval.

18. The apparatus of claim 17, wherein, determining at least one veterinarian associated with a veterinary medicine system further comprises:
retrieving at least a portion of a medical history associated with the animal subject;
determining a user location;
determining one or more veterinarians of a plurality of veterinarians associated with the veterinary medicine system based on at least the retrieved medical history and the user location;
transmitting information associated with the one or more veterinarians to the user device;
receiving, via the operative communication link, a selection of the at least one veterinarian of the one or more veterinarians from the user; and
transmitting the retrieved medical history to the veterinarian system associated with the at least one veterinarian of the one or more veterinarians, selected by the user.

19. The apparatus of claim 17, wherein the first content and the second content comprise at least one of textual content, audio content and video content.

20. The apparatus of claim 17, wherein configuring the first content and the second content for future storage and retrieval further comprises, augmenting a medical history of the animal subject with the first content and the second content.
